(19) United States
(12) Patent Application Publication
(10) Pub. No.: US 2005/0229115 A1
(43) Pub. Date: Oct. 13, 2005

(54) Navigating between associated electronic documents

(76) Inventor: Aurobinda Pradhan, Bangalore (IN)

Correspondence Address: FISH & RICHARDSON, P.C., PO BOX 1022, MINNEAPOLIS, MN, 55440-1022, US

(21) Appl. No.: 10/821,073

(22) Filed: Apr. 8, 2004

(51) Int. Cl. G06F 3/00; G06F 17/21

(52) U.S. Cl. 715/850; 715/713; 715/712; 715/851; 715/760; 715/779; 715/840; 715/810; 715/513; 715/514; 715/501.1

(57) ABSTRACT

A view of a selected electronic document is displayed on a graphical user interface. A user-selectable command is displayed on the graphical user interface while the view of the selected electronic document is displayed. The user-selectable command causes a view of at least one other electronic document that is associated with the selected electronic document to be displayed on the graphical user interface. More than one user-selectable command can be displayed, and the commands may be grouped by categories of association between the documents.

### TECHNICAL FIELD

This description relates to user navigation between electronic documents that are associated with each other.

### BACKGROUND

Most of today's computer systems are capable of storing and handling a great number of electronic documents. These documents may belong to one or more application programs, wherein a user can open a specific document for review and make necessary changes. The systems typically include a graphical user interface by which a view of a stored electronic document can be displayed to the user. These documents are typically stored as separate files and may belong to any of several categories, such as documents for word processing programs, scanned documents, images, electronic forms, spreadsheets, and so on.

From a user's perspective, some of the documents stored in a computer system may be related to each other. Documents can be related because they were created almost simultaneously for similar purposes or because they deal with the same or closely related subjects. Due to the relations between such documents, a user who is viewing one of the documents sometimes wants to review another, related, document. To do so, the user typically must remember a specific address location in the computer system where the sought document is stored, or the user must try to find the document using some search function. Searching for a document may, however, be cumbersome and inefficient, especially if there are many electronic documents stored in the computer system.

Many systems have some form of file folder system for organizing and managing stored electronic documents. For example, most computer operating systems provide that documents (and other files) are stored in file folders that can be individually named, and one or more such folders can be stored in another folder to create a hierarchy for the stored electronic documents. Thus, the user can create a specific folder for a particular subject and store any documents pertaining to that subject in the folder.

There may be disadvantages with the existing approach to managing associated electronic documents. First, it may be inconvenient for the user to have to remember the name and specific location of a file folder in which a related document is stored. If the user does not remember the location, time-consuming searching may have to be performed. Second, even if the user knows the exact location of a related document, the user may have to switch to a separate window to open it, or at least work with dialog boxes that pop up in front of the currently displayed document. Accordingly, existing systems do not provide a convenient way for a user to navigate between electronic documents that are associated with each other.

### SUMMARY

The invention relates to user navigation between electronic documents that are associated with each other.

In a first general aspect, a method comprises displaying a view of a selected electronic document on a graphical user interface. While the view of the selected electronic document is displayed, a user-selectable command is displayed on the graphical user interface. The user-selectable command causes a view of at least one other electronic document that is associated with the selected electronic document to be displayed on the graphical user interface.

In certain embodiments, the selected electronic document is associated with each of a plurality of other electronic documents. In such embodiments, there may be displayed on the graphical user interface a plurality of user-selectable commands for displaying views of the plurality of other electronic documents. Associations between the selected electronic document and each of the plurality of other electronic documents may belong to any of a plurality of association categories. The plurality of user-selectable links may be grouped according to the plurality of association categories. The selected electronic document and the plurality of other electronic documents may form a hierarchy, and one of the association categories may provide navigation upward or downward in the hierarchy.

In a second general aspect, a graphical user interface for user navigation between electronic documents that are associated with each other comprises a document display area wherein a view of a selected electronic document can be displayed, and a user-selectable command that causes, while the view of the selected electronic document is being displayed, a view of at least one other electronic document that is associated with the selected electronic document to be displayed in the document display area.

Advantages of the systems and techniques described herein may include any or all of the following. More efficient management of electronic documents may be provided. User navigation between electronic documents that are associated with each other may be simplified. A graphical user interface may be more user friendly.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A-D is an example of operations that can be performed in a graphical user interface;

FIG. 2 is a flow chart of an embodiment of an inventive method; and

FIG. 3 is a block diagram of a computer system that can generate the graphical user interface shown in FIGS. 1A-D.

Like reference numerals in the various drawings indicate like elements.

### DETAILED DESCRIPTION

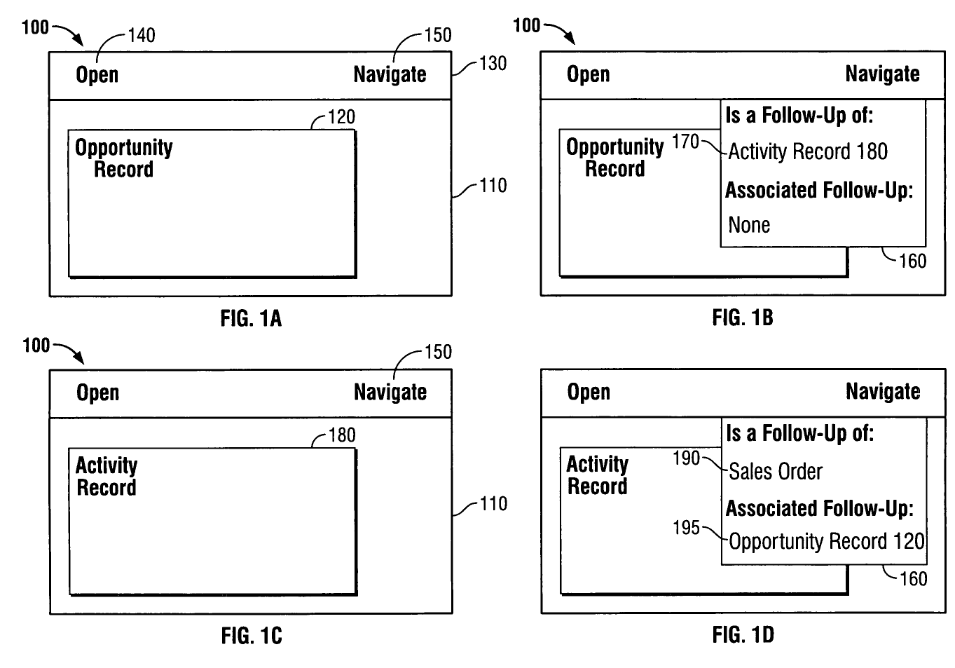

The description of FIGS. 1A-D will be largely based on the following scenario. A business organization has a sales representative who is responsible for sales and service to a particular customer. The sales representative uses a computer device, such as a desktop computer, laptop computer, or handheld device, to create and manage documents that relate to the company's business. At some point in time, the sales representative secures a sales order from the customer and a sales order document is therefore created in the computer system to which the representative's device connects. The sales order will be processed in the system before the order is fulfilled. Later, the sales representative schedules a meeting with the customer, for example to discuss any follow-up issues regarding the order. In preparation for this meeting, the sales representative creates an activity record, an electronic document that summarizes important information about the customer and the purpose of the meeting. The sales representative can review this activity record on the screen of the computer device before or during the meeting. The activity record may therefore be considered as relating to the sales order. During the customer meeting, it appears that the customer also is interested in another product, and the sales representative therefore creates an opportunity record, an electronic document identifying a business opportunity. The opportunity record, in turn, may be considered as a related document to the activity record because of how the opportunity was discovered.

The representative may wish to store and manage these three documents such that the associations between them are apparent. Particularly, the sales representative may wish to conveniently navigate from one of these records to the other, as will be described below. The three documents may be thought of as representing a hierarchy thus:

Sales order

Activity record

Opportunity record

wherein each of the two lower documents is a follow-up of the document preceding it. That is, when the sales representative is viewing one of the electronic documents, he or she may wish to navigate upward in the hierarchy, to the document from which the currently displayed document follows up, or downward in the hierarchy, to a document that follows up on the currently displayed document.

FIG. 1A shows a graphical user interface (GUI) 100 that can provide this navigation. GUI 100 includes a document display area 110 in which a view of an opportunity record 120 is currently being displayed. The GUI 100 further comprises a toolbar 130 that may include controls for performing operations relating to electronic documents, to name just one example. The GUI 100 includes an Open input control 140 that causes views of stored electronic documents to be displayed in the document display area 110. For example, the user may select the opportunity record 120 to be displayed using the Open input control 140.

Assume that while reviewing the opportunity record 120, the user is interested to know more about the circumstances of its creation. For example, the user is the sales representative but no longer remembers exactly how this opportunity was discovered. As another example, the user is someone other than the sales representative who does not know when and why the opportunity record 120 was created.

To see the documents that are associated with the displayed opportunity record 120, the user may select Navigate input control 150, for example using a pointing device. FIG. 1B shows the GUI 100 upon the user's selection, wherein a menu 160 is displayed in the GUI 100. In this example, the menu 160 groups the associated electronic documents in two categories: first, the document on which the currently displayed document follows up (denoted by “Is a Follow-Up of:”) and second, the document(s) that are follow-ups of the currently displayed document (“Associated Follow-Up:”). Other association categories than the ones described here can be used.

In this example, the opportunity record 120 is a follow-up of the activity record, and the former category therefore includes a user selectable command 170 for displaying the activity record. There are currently no follow-up documents from the opportunity record 120 and the latter category in menu 160 is therefore empty. Should follow-up documents be created in the future, they will be identified in this category such that the user can select them for display. It will later be described illustrative examples of how the associations between the documents can be created.

Assume that the user selects the command 170 in menu 160. This causes a predetermined input to be made in the computer device. FIG. 1 C shows a view of activity record 180 being displayed in GUI 100 in response to user selection of command 170. The menu 160 may disappear from the GUI 100 upon the user's selection. Thus, the user navigates from the opportunity record 120 to a related document, the activity record 180. In terms of the above-described document hierarchy, the user has navigated “upward,” that is, from a follow-up document to the preceding document. In this example, one of the association categories provides navigation upward in the hierarchy; the other provides navigation downward. In this example, the view of the activity record 180 replaces the view of the opportunity record 120 in the GUI; i.e., the device ceases to display the view of the opportunity record 120 upon displaying the view of the activity record 180.

The Navigate input control 150 is populated with one or more commands specific to the document that is currently being displayed. If the user selects the control 150 in the exemplary FIG. 1C situation, the menu 160 may appear as shown in FIG. 1D. The command 170 no longer appears in the menu. Rather, the menu 160 indicates that the activity record 180 is a follow-up of the sales order and that the opportunity record 120 is a follow-up of the currently displayed activity record 180. The sales order and opportunity record 120 can be displayed by user selection of the commands 190 and 195, respectively.

Thus, the Navigate input control 150 may provide user navigation between documents that are associated with each other. One may therefore consider the associated documents to be “linked” to each other through use of the control 150. That is, two associated electronic documents may be considered linked to each other if the Navigation input control 150 can provide access to one of them while the other is being displayed.

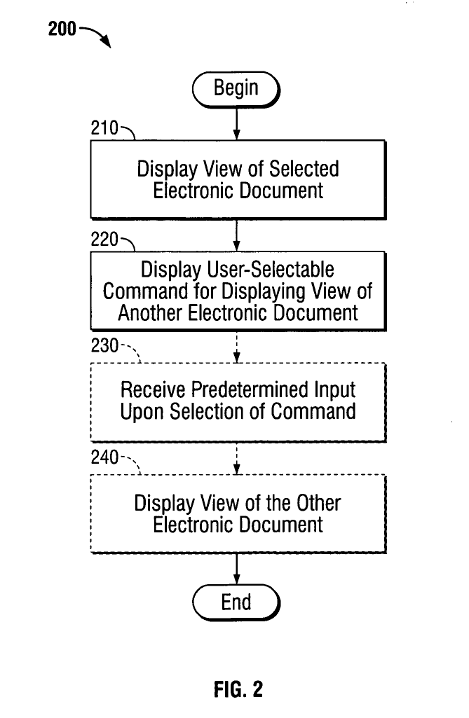

FIG. 2 is a flow chart of a method 200 that can be performed in a computer system that has an electronic document associated with another electronic document. For example, a computer program product can include instructions that cause a processor to perform the steps of the method 200. The method 200 includes the following steps:

Displaying, in step 210, a view of a selected electronic document on a graphical user interface. For example, a view of the opportunity record 120 can be displayed on the GUI 100.

Displaying, in step 220, a user-selectable command that causes a view of at least one other electronic document to be displayed on the graphical user interface. The other electronic document is associated with the selected electronic document. The command is displayed while the view of the selected electronic document is being displayed. For example, the exemplary activity record 180 is associated with the opportunity record 120, and the user-selectable command 170 can be displayed on the GUI 100 while the view of the opportunity record 120 is being displayed. The exemplary command 170 causes the view of the activity record 180 to be displayed on the GUI 100.

Receiving, in optional step 230, a predetermined input upon a user selecting the user-selectable command. For example, the predetermined input may be received upon user selection of the command 170.

Displaying, in optional step 240, the view of the at least one other electronic document on the graphical user interface. The view is displayed in response to receiving the predetermined input. For example, the view of the activity record 180 can be displayed in the GUI 100 in response to user selection of the command 170.

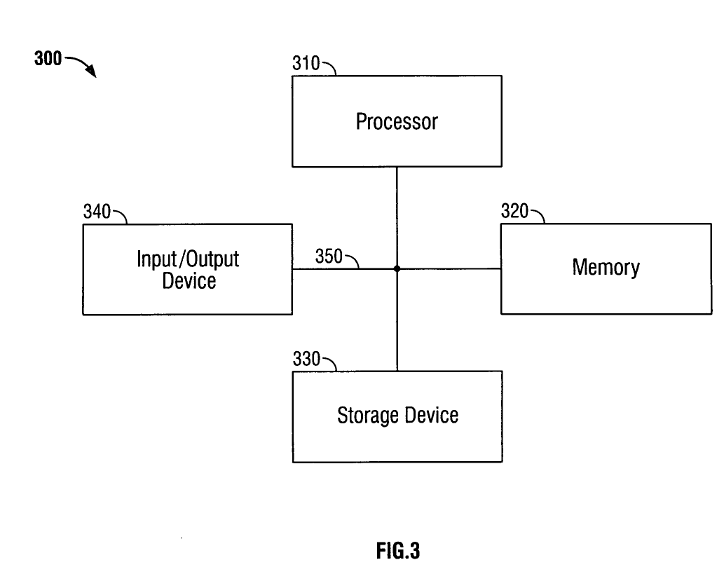

FIG. 3 is a block diagram of a computer system 300 that can be used in the operations described above, according to one embodiment. The system 300 includes a processor 310, a memory 320, a storage device 330 and an input/output device 340. Each of the components 310, 320, 330 and 340 are interconnected using a system bus 350. The processor 310 is capable of processing instructions for execution within the system 300. In one embodiment, the processor 310 is a single-threaded processor. In another embodiment, the processor 310 is a multi-threaded processor. The processor 310 is capable of processing instructions stored in the memory 320 or on the storage device 330 to display graphical information for a user interface on the input/output device 340.

The memory 320 stores information within the system 300. In one embodiment, the memory 320 is a computer-readable medium. In one embodiment, the memory 320 is a volatile memory unit. In another embodiment, the memory 320 is a non-volatile memory unit.

The storage device 330 is capable of providing mass storage for the system 300. In one embodiment, the storage device 330 is a computer-readable medium. In various different embodiments, the storage device 330 may be a floppy disk device, a hard disk device, an optical disk device, or a tape device.

The input/output device 340 provides input/output operations for the system 300. In one embodiment, the input/output device 340 includes a keyboard and/or pointing device. In one embodiment, the input/output device 340 includes a display unit for displaying graphical user interfaces as discussed above with reference to FIGS. 1A-D.

Association between related electronic documents in the system 300 may occur in different ways. First, when a new electronic document is created, it can automatically be associated with another document in the system 300, for example because the user makes a specific input signifying that the new document is to be associated with one or more existing electronic documents in the system. In one implementation, the input/output device 340 provides a graphical user interface with a user-selectable input control for creating a new document to be associated with a currently displayed electronic document. Second, the system 300 may provide that a user can associate two or more documents that are already stored therein. That is, the user can select the documents using a suitable graphical user interface, and make a specific input that causes the system to associate the selected documents with each other. Both of these exemplary approaches may provide that the user can specify the category of association that is to be established, e.g., a follow-up document.

One example of how documents are associated is the use of identifiers. The system 300 can store an identifier in association with one or more documents to indicate the associations between them. That is, the system 300 can store an identifier in association with an electronic document to indicate that it is associated with (for example, a follow-up of) another electronic document. In some implementations, another identifier is stored in association with the other electronic document. The stored identifiers may thereafter be used for navigating between associated electronic documents, as described above.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method to be performed in a computer system having stored therein an electronic document that is associated with another electronic document, the method comprising:
displaying a view of a selected electronic document on a graphical user interface; and
displaying on the graphical user interface, while displaying the view of the selected electronic document, a user-selectable command that causes a view of at least one other electronic document that is associated with the selected electronic document to be displayed on the graphical user interface.

2. The method of claim 1, wherein the user-selectable command is displayed in response to a user selecting an input control in a toolbar of the graphical user interface.

3. The method of claim 1, wherein the selected electronic document is associated with each of a plurality of other electronic documents, and wherein the method further comprises displaying on the graphical user interface a plurality of user-selectable commands for displaying views of the plurality of other electronic documents.

4. The method of claim 3, wherein associations between the selected electronic document and each of the plurality of other electronic documents belong to any of a plurality of association categories.

5. The method of claim 4, wherein the method further comprises grouping the plurality of user-selectable links according to the plurality of association categories.

6. The method of claim 4, wherein the selected electronic document and the plurality of other electronic documents form a hierarchy.

7. The method of claim 6, wherein one of the association categories provides navigation upward in the hierarchy.

8. The method of claim 6, wherein one of the association categories provides navigation downward in the hierarchy.

9. The method of claim 1, further comprising:
receiving a predetermined input upon a user selecting the user-selectable command; and
in response to receiving the predetermined input, displaying on the graphical user interface the view of the at least one other electronic document.

10. The method of claim 9, further comprising ceasing to display the view of the selected electronic document upon displaying the at least one other electronic document.

11. The method of claim 9, further comprising displaying another user-selectable command on the graphical user interface that causes the view of the selected electronic document to be displayed on the graphical user interface.

12. A computer program product tangibly embodied in an information carrier, the computer program product including instructions that, when executed, cause a processor to perform instructions comprising:
display a view of a selected electronic document on a graphical user interface; and
display on the graphical user interface, while displaying the view of the selected electronic document, a user-selectable command that causes a view of at least one other electronic document that is associated with the selected electronic document to be displayed on the graphical user interface.

13. The computer program product of claim 12, wherein the operations further comprise:
receive a predetermined input upon a user selecting the user-selectable command; and
in response to receiving the predetermined input, display on the graphical user interface the at least one other electronic document.

14. A computer program product tangibly embodied in an information carrier, the computer program product including instructions that, when executed, generate on a display device a graphical user interface for user navigation between electronic documents that are associated with each other, the graphical user interface comprising:
a document display area wherein a view of a selected electronic document can be displayed; and
a user-selectable command that causes, while the view of the selected electronic document is being displayed, a view of at least one other electronic document that is associated with the selected electronic document to be displayed in the document display area.

15. The computer program product of claim 14, wherein the graphical user interface further includes a toolbar with an input control, wherein the user-selectable command appears in a menu that is displayed on the graphical user interface upon user selection of the input control.

16. The computer program product of claim 14, wherein the selected electronic document is associated with each of a plurality of other electronic documents, and wherein the graphical user interface includes a plurality of user-selectable commands for displaying views of the plurality of other electronic documents.

17. The computer program product of claim 16, wherein associations between the selected electronic document and each of the plurality of other electronic documents belong to any of a plurality of association categories, and wherein the plurality of user-selectable commands is grouped according to the plurality of association categories.

18. The computer program product of claim 17, wherein the selected electronic document and the plurality of other electronic documents form a hierarchy.

19. The computer program product of claim 18, wherein one of the association categories provides navigation upward in the hierarchy.

20. The computer program product of claim 18, wherein one of the association categories provides navigation downward in the hierarchy.
